(19) United States
(12) Patent Application Publication
(10) Pub. No.: US 2018/0271168 A1
(43) Pub. Date: Sep. 27, 2018

(54) MONO-DIRECTIONAL MOUTHPIECE, ATOMIZER AND ELECTRONIC CIGARETTE HAVING THE SAME

(71) Applicant: CHANGZHOU JWEI INTELLIGENT TECHNOLOGY CO., LTD., Changzhou (CN)

(72) Inventor: Weihua QIU, Changzhou (CN)

(21) Appl. No.: 15/990,334

(22) Filed: May 25, 2018

Related U.S. Application Data
(63) Continuation-in-part of application No. PCT/CN2016/108644, filed on Dec. 6, 2016.

(30) Foreign Application Priority Data
Dec. 13, 2015 (CN) 201510914739.8
Dec. 13, 2015 (CN) 201521026496.6

(51) Int. Cl. A24F 47/00; F16K 15/14

(52) U.S. Cl. CPC A24F 47/008; F16K 15/14

(57) ABSTRACT

An electronic cigarette has an atomizer and a mono-directional mouthpiece. The mono-directional mouthpiece includes a first valve, a second valve, a blocking plate, and an elastic member. The first valve defines a first valve airway. The second valve is fixedly connected to the first valve and defines a second valve airway. The blocking plate defines a blocking plate airway fluidly communicating with the first valve airway and the second valve airway. Connecting ends of the first valve and the second valve which connect the first valve to the second valve both define a groove.

### CROSS-REFERENCE TO RELATED APPLICATIONS

This application is a continuation-in-part application claiming benefit of International Patent Application NO. PCT/CN2016/108644 filed on Dec. 6, 2016, which claims priority to Chinese Patent Application NO. 201521026496.6 filed on Dec. 13, 2015 and NO. 201510914739.8 filed on Dec. 13, 2015.

### TECHNOLOGY FIELD

The invention relates to a technical field of electronic cigarettes, and more particularly, relates to a mono-directional mouthpiece, an atomizer having the mono-directional mouthpiece and an electronic cigarette having the atomizer.

### BACKGROUND

Electronic cigarette is also known as virtual cigarette or electronic atomizer. The electronic cigarette is used as an alternative product for conventional cigarette, and is gradually accepted by common people. The electronic cigarette generally includes a mouthpiece for the user to suck.

At present, the electronic cigarette in the market is more and more popular. However, the electronic cigarette is easy to be treated as a toy and be mistakenly sucked by children, thereby affecting children's health, there is a potential safety hazard. Therefore, in some countries and regions, it gets more emphasis that a children protective function should be equipped on the electronic cigarette.

### SUMMARY

Accordingly, it is necessary to provide a mono-directional mouthpiece having a children protective function, an atomizer having the mono-directional mouthpiece, and an electronic cigarette.

A mono-directional mouthpiece, includes a first valve, a second valve, a blocking plate, and an elastic member. The first valve defines a first valve airway. The second valve is fixedly connected to the first valve and defines a second valve airway. The blocking plate defines a blocking plate airway fluidly communicating with the first valve airway and the second valve airway. Connecting ends of the first valve and the second valve which connect the first valve to the second valve both define a groove. The two grooves are defined on corresponding positions of the two connecting ends respectively, the two grooves fluidly communicate with each other to form a moving space. The blocking plate and the elastic member are positioned in the moving space, the blocking plate is positioned in the groove of the first valve which is located at a bottom of the first valve. An end of the elastic member resists the blocking plate, an opposite end of the elastic member extends into an inner of the groove of the second valve, the blocking plate is capable of moving along an axial direction of the moving space reciprocally.

According to an embodiment, the mono-directional mouthpiece further includes a mouthpiece cover, wherein the mouthpiece cover is mounted on the first valve or the second valve.

According to an embodiment, the blocking plate includes a guiding post, the blocking plate airway is defined on the guiding post, the first valve airway, the second airway and the blocking plate airway fluidly communicate with each other.

According to an embodiment, the mono-directional mouthpiece further includes a sealing ring, the sealing ring is positioned on a portion of the first valve which is connected to a mouthpiece cover or an atomizing body. Or the sealing ring is positioned on a portion of the second valve which is connected to a mouthpiece cover or an atomizing body.

According to an embodiment, wherein the first valve is fixedly connected to the second valve by any one or any combination of connecting types selected from microwave joining, hot melting, screwing or latching.

According to an embodiment, wherein the first valve and/or the second valve are/is marked, for distinguishing the first valve from the second valve.

An atomizer, includes an atomizing body and a mouthpiece positioned on the atomizing body, wherein the mouthpiece is any one of aforementioned mono-directional mouthpiece.

An electronic cigarette, includes an aforementioned atomizer.

A mono-directional mouthpiece, includes a first valve, a second valve, a blocking plate, a mono-directional membrane, and a fixing member. The first valve defines a first valve airway. The second valve is fixedly connected to the first valve and defines a second valve airway. The blocking plate defines a blocking plate airway. A connecting end of the first valve connecting with the second valve defines a groove. The blocking plate is resisted in the groove of the first valve, the fixing member fixes a portion of the mono-directional membrane to the blocking plate. The second valve defines a moving space therein for a movable portion of the mono-directional membrane to move toward the second valve. When the movable portion of the mono-directional membrane moves toward the second valve, the first valve airway and the second valve airway fluidly communicate with each other via the blocking plate airway.

According to an embodiment, the fixing member is a protrusion positioned on a central of a fixing plate, the protrusion resists a central of the mono-directional membrane on the blocking plate to fix the mono-directional membrane to the blocking plate. A connecting end of the second valve connecting with the first valve defines a groove, the fixing plate is positioned in the groove of the second valve, the fixing plate defines a fixing plate airway. When the movable portion of the mono-directional membrane moves toward the second valve, the first valve airway, the blocking plate airway, the fixing plate airway, and the second valve airway fluidly communicate with each other.

According to an embodiment, wherein the fixing member is a magnetic member, at least a portion of the blocking plate is magnetic, when the fixing member and the blocking plate are magnetic sucked together, a portion of the mono-directional membrane positioned between the fixing member and the blocking plate is fixed.

According to an embodiment, wherein the fixing member includes a first fixing portion and a resisting portion, the first fixing portion is embedded into the blocking plate, causing the fixing member to be fixed to the blocking plate, the resisting portion resists a portion of the membrane on the blocking plate.

According to an embodiment, wherein the fixing member is an adhering portion positioned on the blocking plate and/or an adhering portion positioned on the mono-directional membrane, the mono-directional membrane is partially adhered to and fixed to the blocking plate.

According to an embodiment, the mono-directional mouthpiece further includes a mouthpiece cover, the mouthpiece cover is mounted on the first valve or the second valve, the mouthpiece defines a mouthpiece cover airway.

According to an embodiment, the mono-directional mouthpiece further includes a sealing ring. The sealing ring is positioned on a portion of the first valve which is connected to a mouthpiece cover or an atomizing body. Or the sealing ring is positioned on a portion of the second valve which is connected to a mouthpiece cover or an atomizing body

According to an embodiment, wherein the first valve is fixedly connected to the second valve by any one or any combination of connecting types selected from microwave joining, hot melting, screwing or latching.

According to an embodiment, wherein the first valve and/or the second valve are/is marked, for distinguishing the first valve from the second valve.

An atomizer, includes an atomizing body and a mouthpiece, the mouthpiece is positioned on the atomizing body, wherein the mouthpiece is any one of the aforementioned mono-directional mouthpiece.

An electronic cigarette, includes an aforementioned atomizer.

In the mono-directional mouthpiece, due to a configuration of the blocking plate, the air flow can circulate fluently when the mono-directional mouthpiece is sucked from a particular direction. When the mono-directional mouthpiece is sucked from another direction, the air flow is blocked by the blocking plate and cannot flow, thus the user cannot swallow the smog in the atomizer.

### BRIEF DESCRIPTION OF THE DRAWINGS

The invention is specifically illustrated with reference to accompanying drawings and embodiments in the following description.

FIG. 1 is an exploded view of a mono-directional mouthpiece of a first embodiment of the present disclosure;

FIG. 2 is a cross-sectional view of the mono-directional mouthpiece of FIG. 1, taken along line A-A;

FIG. 3 is a cross-sectional view of the mono-directional mouthpiece of FIG. 1, after the mono-directional mouthpiece is assembled;

FIG. 4 is an isometric view of an atomizer (the first valve of the mono-directional mouthpiece is mounted on the atomizing body) of the present disclosure, which has the mono-directional mouthpiece of FIG. 1;

FIG. 5 is a cross-sectional view of the atomizer of FIG. 4;

FIG. 6 is an isometric view of an electronic cigarette of the present disclosure, which has the atomizer of FIG. 4;

FIG. 7 is an exploded view of a mono-directional mouthpiece of a second embodiment of the present disclosure;

FIG. 8 is a cross-sectional view of the mono-directional mouthpiece of FIG. 7 after being disassembled;

FIG. 9 is a cross-sectional view of the mono-directional mouthpiece of FIG. 7 after being assembled;

FIG. 10 is an enlarged view of circled portion A of the mono-directional mouthpiece of FIG. 9;

FIG. 11 is a cross-sectional view of a mono-directional mouthpiece of a third embodiment of the present disclosure;

FIG. 12 is a cross-sectional view of a mono-directional mouthpiece of a fourth embodiment of the present disclosure;

FIG. 13 is a cross-sectional view of a mono-directional mouthpiece of a fifth embodiment of the present disclosure;

FIG. 14 is a top view of a mono-directional membrane of FIG. 12, showing a surface of the mono-directional membrane having an adhering portion;

FIG. 15 is a cross-sectional view of a mono-directional mouthpiece of a sixth embodiment of the present disclosure; and

FIG. 16 is an isometric view of an electronic cigarette of a seventh embodiment of the present disclosure.

### DETAILED DESCRIPTION OF THE PREFERRED EMBODIMENT

Technical solutions in the embodiments of the present application will be described clearly and thoroughly hereinafter with reference to the accompanying drawings. Apparently, the embodiments described herein are merely parts of but not exclusive embodiments of the present application. All alternative embodiments obtained by those skilled in the art based on the embodiments of the present application without creative works shall fall within the protection scope of the present application.

The invention is specifically illustrated with reference to accompanying drawings. The accompanying drawings are schematic views which simplified shows fundamental structures of an exemplary embodiment of the invention. Thus, merely the constructions related to the invention are shown.

### The First Embodiment

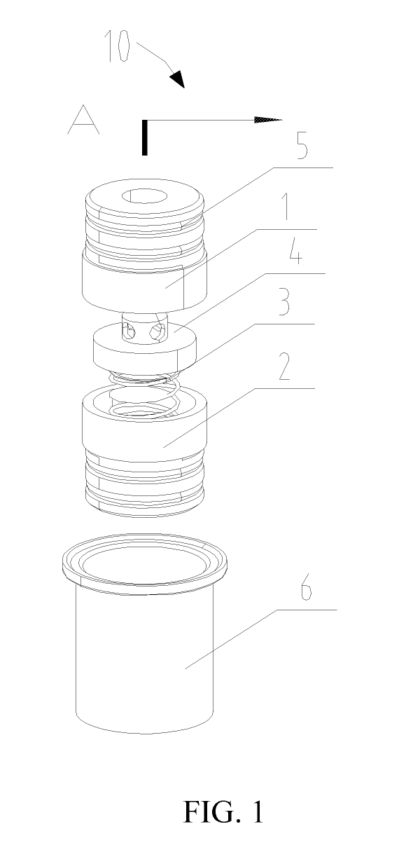

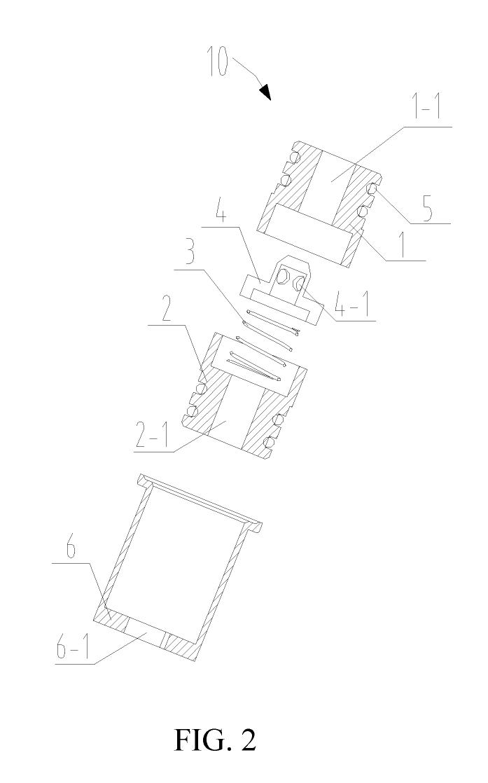

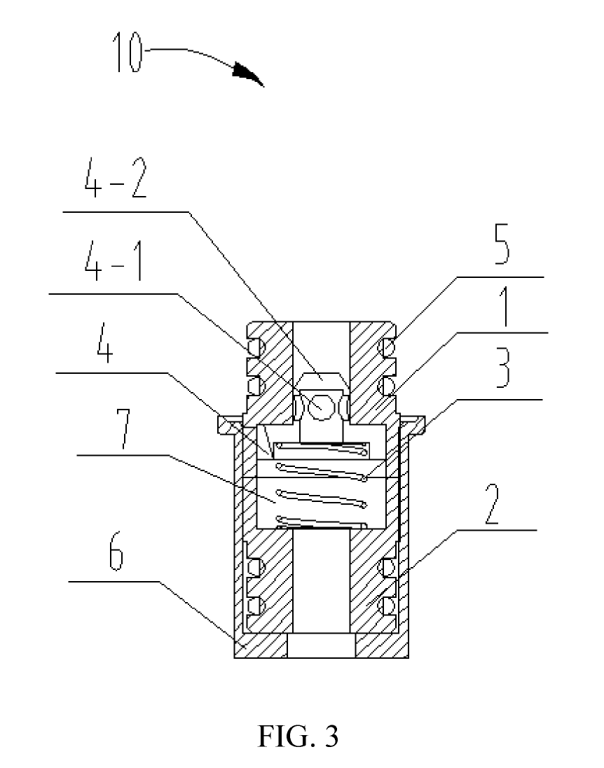

Referring to FIG. 1 through FIG .3, the first embodiment of the present disclosure provides a mono-directional mouthpiece 10, the mono-directional mouthpiece 10 includes a first valve 1, a second valve 2, an elastic member 3, and a blocking plate 4, the first valve 1 is fixedly connected to the second valve 2. The first valve 1 is connected to the second valve 2 by any one of the connecting types of microwave joining, hot melting, screwing or latching. The first valve 1 defines a first valve airway 1-1, the second valve 2 defines a second valve airway 2-1. Connecting ends of the first valve 1 and the second valve 2 which connect the first valve 1 to the second valve both define a groove, the two grooves are defined on corresponding positions of the first valve 1 and the second valve 2, respectively, the two grooves fluidly communicate with each other to form an internal moving space 7, the blocking plate 4 and the elastic member 3 are positioned in the moving space 7. The blocking plate 4 resists a bottom end of the first valve 1, the elastic member 3 is resisted between the blocking plate 4 and the second valve 2. The blocking plate 4 further defines a blocking plate airway 4-1. The blocking plate 4 is configured to perform an axial movement along an inner wall of the moving space 7. When the mono-directional mouthpiece 10 is assembled along a right direction, the first valve airway 1-1 and the second valve airway 2-1 fluidly communicate with each other via the blocking plate airway 4-1, which is prepared for the user to suck.

In the mono-directional mouthpiece, due to a configuration of the blocking plate, the air flow can circulate fluently when the mono-directional mouthpiece is sucked from a particular direction. When the mono-directional mouthpiece is sucked from another direction, the air flow is blocked by the blocking plate and cannot flow, thus the user cannot swallow the smog in the atomizer.

In the illustrated embodiment, the elastic member 3 is a spring. It can be understood that the elastic member 3 can be other types of elastic plastic member.

The mono-directional mouthpiece 10 of the illustrated embodiment further includes a mouthpiece cover 6, the mouthpiece cover 6 is mounted on the first valve 1 or the second valve 2. The mouthpiece cover 6 can improve a universality of an electronic cigarette. For different users, when smoking the electronic cigarette, merely the mouthpiece cover 6 is required to be replaced. Alternatively, the mouthpiece cover 6 can be made of acrylic or silica gel, which provides an anti-scald function to some extent. The mouthpiece cover 6 defines a mouthpiece cover airway 6-1.

The blocking plate 4 further includes a section of guiding post 4-2, the blocking plate airway 4-1 is defined on the guiding post 4-2, and the guiding post 4-2 extends into an inner of the first valve 1.

The mono-directional mouthpiece 10 of the illustrated embodiment further includes a sealing ring 5. When assembly, the blocking plate 4 is assembled to the first valve 1, the blocking plate 4 presses the elastic member 3, and then the first valve 1 is assembled in the second valve 2. The sealing rings 5 are sleeved in slots of the second valve 2 and the first valve 1. When the mouthpiece cover 6 is assembled to the second valve 2 or the first valve 1, the sealing rings 5 can provide a sealing function. When the mouthpiece cover 6 is assembled to one end of the mono-directional mouthpiece 10, the unoccupied end of the mono-directional mouthpiece 10 is assembled to the atomizing body 120. Because opposite ends of the mono-directional mouthpiece 10 are provided with sealing rings 5, thus the sealing ring 5 on the valve which is inserted in the atomizing body 120 also provides a sealing function for the atomizing body 120.

When use, the mouthpiece cover 6 is assembled the second valve 2, at the time, the first valve 1 is assembled to the atomizing body 120. The user sucks the mouthpiece cover 6, an air flow drives the blocking plate 4 to perform an axial movement along the inner wall of the moving space 7 between the first valve 1 and the second valve 2, and the elastic member 3 is compressed. At the time, the first valve airway 1-1, the blocking plate airway 4-1, the second valve airway 2-1, and the mouthpiece cover airway 6-1 fluidly communicate with each other, causing the airflow to externally enter user's mouth via the first valve airway 1-1, the blocking plate airway 4-1, the second valve airway 2-1, and the mouthpiece cover airway 6-1 successively. When the mono-directional mouthpiece 6 is assembled to the first valve 1, the second valve 2 is connected to the atomizing body 120. At the time, the first valve airflow 1-1 and the second valve 2-1 are blocked by the blocking plate 4. When the mono-directional mouthpiece 6 is sucked, the airflow and the elastic member 3 apply a press to the blocking plate 4 together, causing the first valve airway 1-1 to generate a negative air pressure, and the blocking plate 4 blocks the airflow, causing the air flow cannot enter the mouthpiece cover 6, thus the smog in the atomizing body 120 cannot be sucked. As an adult, if the mono-directional mouthpiece 10 cannot be sucked, when one end of the mono-directional mouthpiece 10 inserts into the atomizing body 120, it can be readily envisaged that trying to insert an opposite end of mono-directional mouthpiece 10 into the atomizing body 120. While for an infant, it is difficult to try like that, thus it can prevent a mistakenly swallow by an infant.

In an illustrated embodiment, the first valve 1 and the second valve 2 can be marked, facilitating for recognizing a right direction from outside of the first valve 1 and the second valve 2. When it is not used, the mono-directional mouthpiece 10 is reversely assembled (i.e. the mouthpiece cover 6 is sleeved on the first valve 1, and the second valve 2 is inserted into the atomizing body), thus the following phenomenon can be avoided: the electronic cigarette is treated as a toy and be sucked by children mistakenly which affects children's health and has a potential safety hazard.

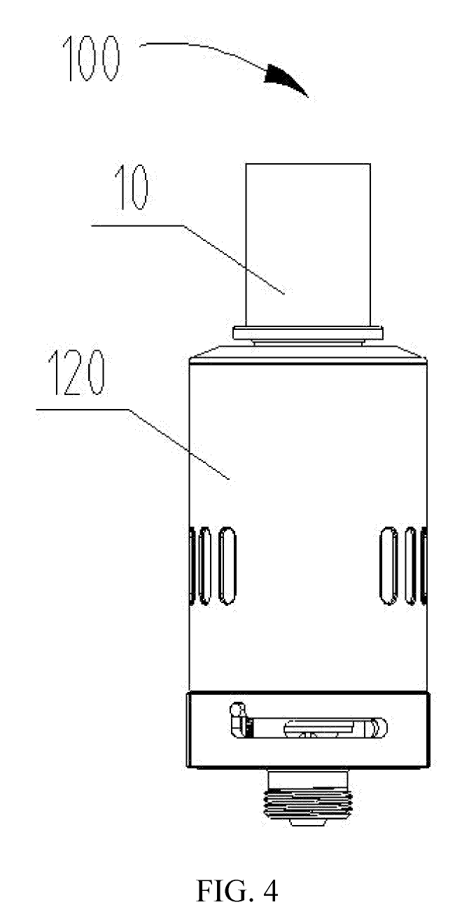

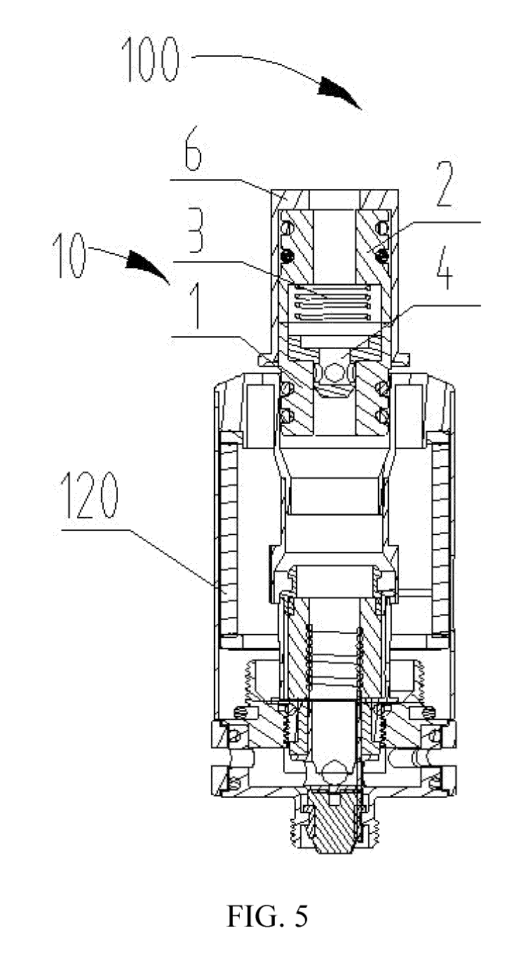

Referring to FIG. 4 and FIG. 5, the present disclosure further provides an atomizer 100, the atomizer 100 includes an atomizing body 120 and a mono-directional mouthpiece 10 assembled to the atomizing body 120.

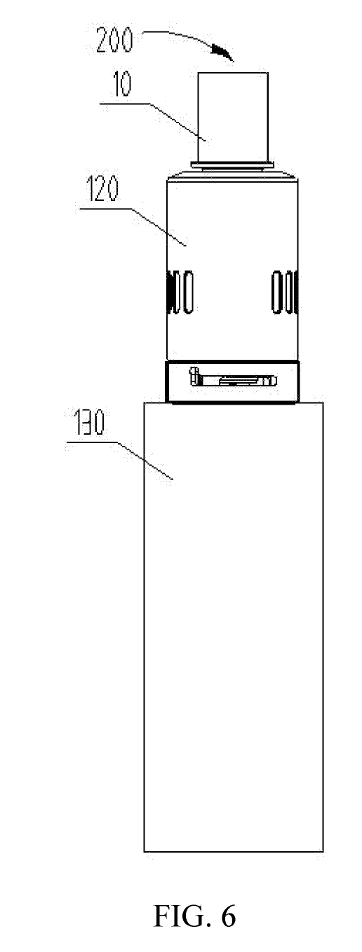

Referring to FIG. 6, the present disclosure further provides an electronic cigarette 200, the electronic cigarette 200 includes an atomizing body 120, a mono-directional mouthpiece 10 assembled to the atomizing body 120, and a battery pack 130 configured to supply power for the atomizing body 120. The battery pack 130 is assembled to an end of the atomizing body 120 distal from the mono-directional mouthpiece 10.

### The Second Embodiment

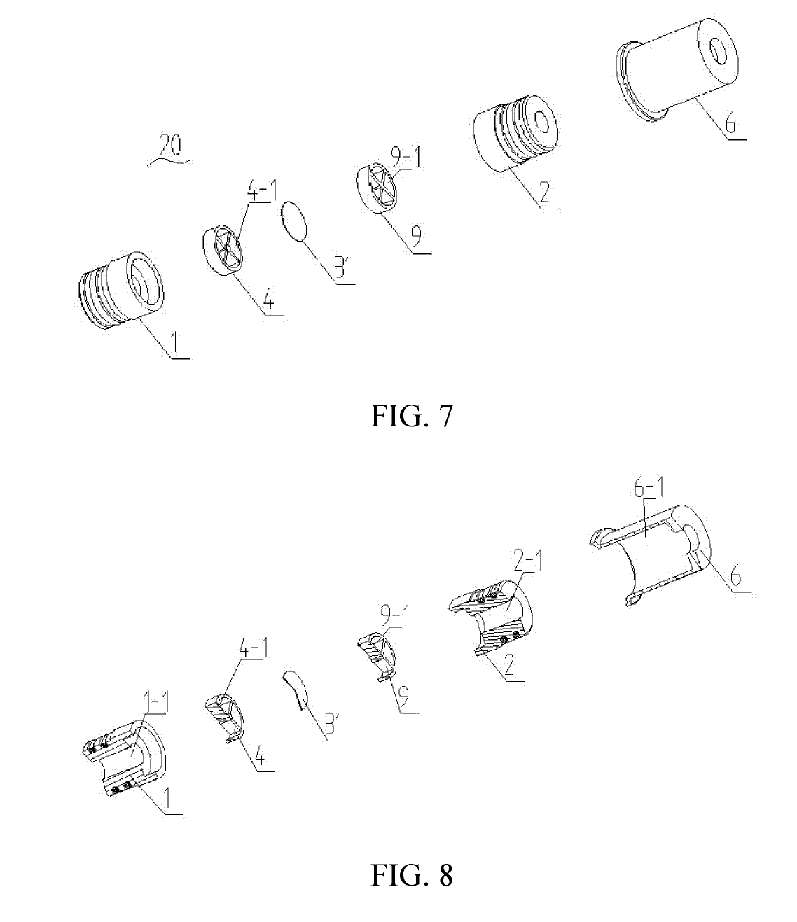

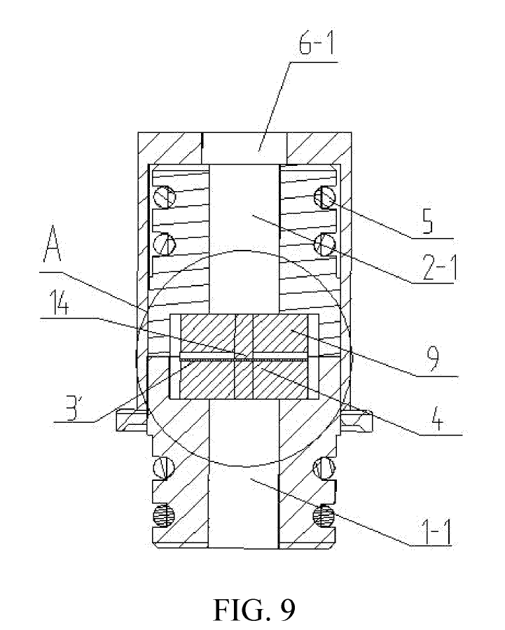

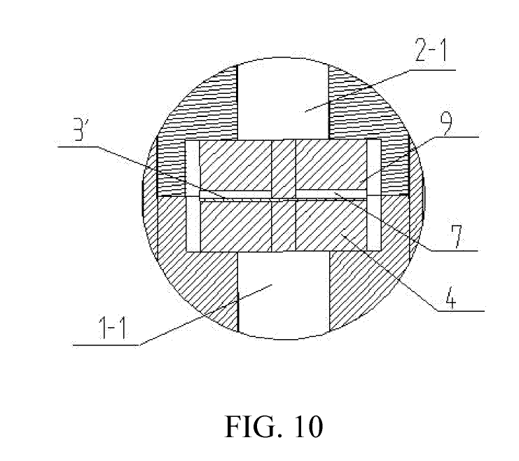

Referring to FIG. 7 and FIG. 10, the second embodiment of the present disclosure discloses a mono-directional mouthpiece 20 for an electronic cigarette. The mono-directional mouthpiece 20 includes a first valve 1, a blocking plate 4, a mono-directional membrane 3′, a fixing member 14 and a second valve 2. The second valve 2 is fixedly connected to the first valve 1 by any one or a combination of the connecting types selected from microwave joining, hot melting, screwing or latching. The first valve 1 defines a first valve airway 1-1, the second valve 2 defines a second valve airway 2-1. A connecting end of the first valve 1 connecting with the second valve 2 defines a groove, the blocking plate 4 is resisted in the groove of the first valve 1. The fixing member 14 fixes a portion of the mono-directional membrane 3′ to the blocking plate 4, the second valve 2 defines a moving space 7 therein for a movable portion of the mono-directional membrane 3′ to move toward the second valve 2. The first valve 1 defines a first valve airway 1-1, the blocking plate 4 defines a blocking plate airway 4-1, the second valve 2 defines a second valve airway 2-1, when the movable portion of mono-directional membrane 3′ moves toward the second valve 2, the first valve airway 1-1 and the second valve airway 2-1 fluidly communicate with each other via the blocking plate airway 4-1, for the user to swallow.

In the illustrated embodiment, the fixing member 14 is a protrusion positioned on a center of a fixing plate 9, the protrusion resists a central of the mono-directional membrane 3′ on the blocking plate 4 and fixes the mono-directional membrane 3′ to the blocking plate 4. A connecting end of the second valve 2 connecting with the first valve 1 defines a groove, the fixing plate 9 is resisted in the groove of the second valve 2. The fixing plate 9 defines a fixing plate airway 9-1. When the movable portion of the mono-directional membrane 3′ moves toward the second valve 2, the first valve airway 1-1, the blocking plate airway 4-1, the fixing plate airway 9-1, and the second valve airway 2-1 fluidly communicate with each other, for the user to swallow.

The mono-directional mouthpiece 20 of the illustrated embodiment further includes a mouthpiece cover 6, the mouthpiece cover 6 is mounted on the first valve 1 or the second valve 2. The mouthpiece cover 6 defines a mouthpiece cover airway 6-1. The mouthpiece cover 6 can improve a universality of an electronic cigarette. For different users, when sucking the electronic cigarette, merely the mouthpiece cover 6 is required to be replaced. Alternatively, the mouthpiece cover 6 can be made of acrylic or silica gel, which provides an anti-scald function to some extent

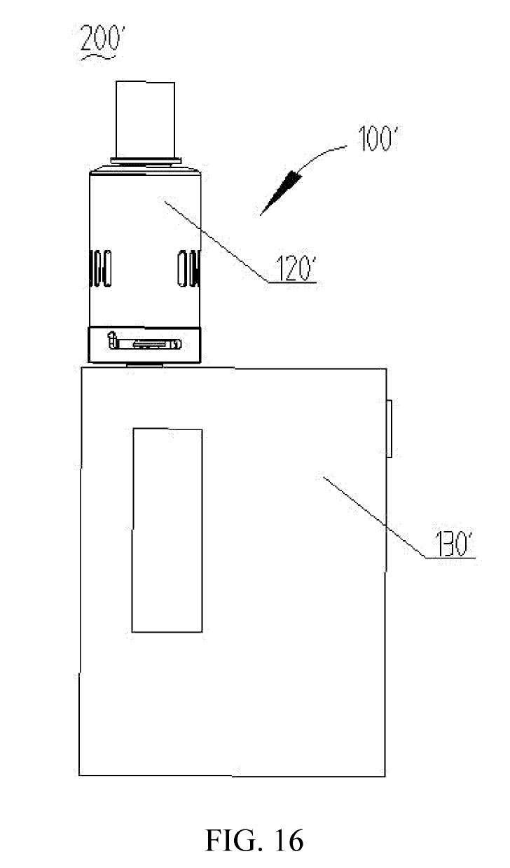

The mono-directional mouthpiece 20 of the illustrated embodiment further includes a sealing ring 5. When assembly, the blocking plate 4 is assembled to the first valve 1, the mono-directional membrane 3′ is positioned on the blocking plate 4, and the fixing member 14 resists on a center of the mono-directional membrane 3′, and then the second valve 2 is assembled. The sealing rings 5 are sleeved on corresponding slots of the second valve 2 and the first valve 1. When the mouthpiece cover 6 is assembled to the second valve 2 or the first valve 1, the sealing rings 5 can provide a sealing function. Further referring to FIG. 16, when the mouthpiece cover 6 is assembled to any end of the mono-directional mouthpiece 20, the unoccupied end of the mono-directional mouthpiece 20 is assembled to the atomizing body 120′. Because opposite ends of the mono-directional mouthpiece 20 are provided with sealing rings 5, thus the sealing ring 5 on the valve which is inserted in the atomizing body 120′ also provides a sealing function for the atomizing body 120′.

When used, the mouthpiece cover 6 is assembled to the second valve 2, at the time, the first valve 1 is assembled to the atomizing body 120′. When user sucks the mouthpiece cover 6, the movable portion of the mono-directional membrane 3′ is driven by the air flow to curl. At the time, the first valve airway 1-1, the blocking plate airway 4-1, the fixing plate airway 9-1, the second valve airway 2-1, and the mouthpiece cover airway 6-1 fluidly communicate with each other, causing the airflow to externally enter user's mouth via the first valve airway 1-1, the blocking plate airway 4-1, the fixing plate airway 9-1, the second valve airway 2-1, and the mouthpiece cover airway 6-1 successively. When the mono-directional mouthpiece 6 is assembled to the first valve 1, the second valve body 2 is assembled to the atomizing body 120′. When the user sucks, because there is no moving space 7 between the mono-directional membrane 3′ and the blocking plate 4, the mono-directional membrane 3′ cannot be curled to open the blocking plate airway 4-1, thus the mono-directional membrane 3′ blocks the air flow, i.e. the first valve airway 1-1 and the second valve airway 2-1 are blocked by the mono-directional membrane 3′, causing the airflow cannot enter the mouthpiece cover 6, thus the smog in the atomizing body 120′ cannot be swallowed. As an adult, if the mono-directional mouthpiece 20 cannot be sucked, when one end of the mono-directional mouthpiece 20 inserts into the atomizing body 120′, it can be readily envisaged that trying to insert an opposite end of mono-directional mouthpiece 20 into the atomizing body 120′. While for an infant, it is difficult to try like that, thus it can prevent a mistakenly swallow by an infant.

Further, the first valve 1 and the second valve 2 can be marked, facilitating for recognizing a right direction from outside. When it is not used, the mono-directional mouthpiece 20 is reversely assembled (i.e. the mouthpiece cover 6 is sleeved on the first valve 1), thus the following phenomenon can be avoided: the electronic cigarette is treated as a toy and be sucked by children mistakenly which affects children's health and has a potential safety hazard

### The Third Embodiment

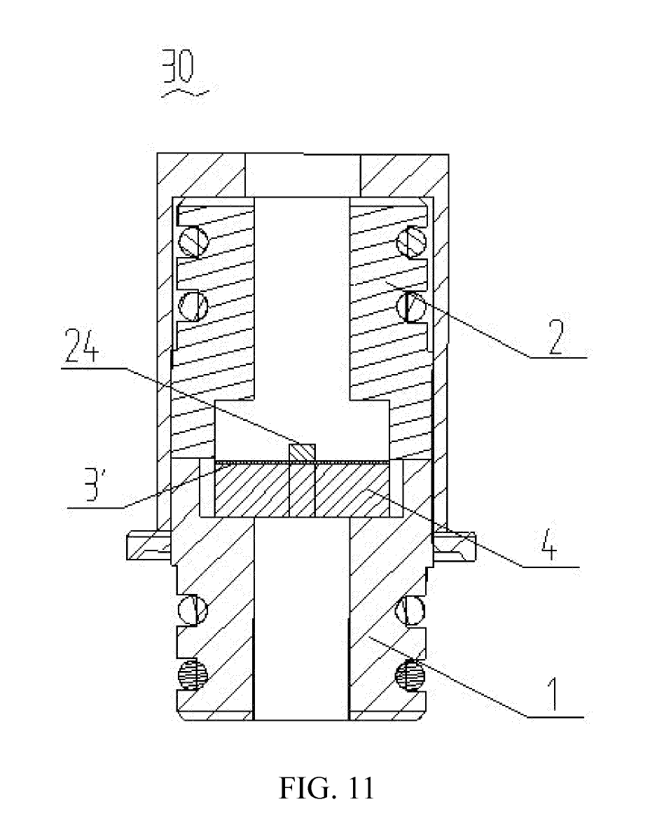

Referring to FIG. 11, the third embodiment of the present disclosure provides a mono-directional mouthpiece 30 for an electronic cigarette, the mono-directional mouthpiece 30 includes a first valve 1, a blocking plate 4, a mono-directional membrane 30′, a fixing member 24, and a second valve 2. The difference between the third embodiment and the second embodiment is that: the fixing member 24 is a magnetic member, at least a portion of the blocking plate 4 is magnetic, when the fixing member 24 and the blocking plate 4 are magnetic sucked together, the portion of the mono-directional membrane 3′ positioned between the fixing member 24 and the blocking plate 4 is fixed.

### The Fourth Embodiment

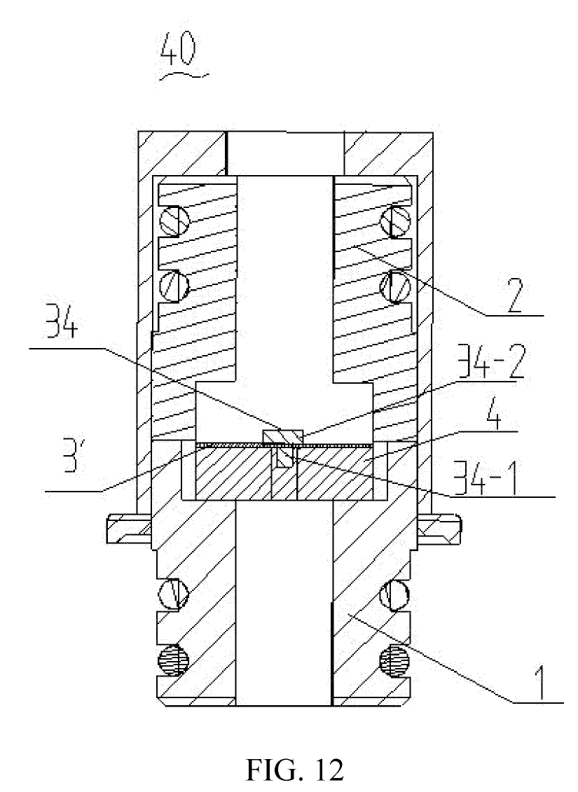

Referring to FIG. 12, the fourth embodiment of the present disclosure provides a mono-directional mouthpiece 40 for an electronic cigarette, the mono-directional mouthpiece 40 includes a first valve 1, a blocking plate 4, a mono-directional membrane 3′, a fixing member 24, and a second valve 2. The difference between the fourth embodiment and the second embodiment is that: the fixing member 34 includes a first fixing portion 34-1 and a resisting portion 34-2, the first fixing portion 34-1 is embedded into the blocking plate 4, causing the fixing member 34 to be fixed to the blocking plate 4. The resisting portion 34-2 resists a portion of the membrane 3′ on the blocking plate 4, and fixes the portion of the membrane 3′ to the blocking plate 4.

### The Fifth Embodiment

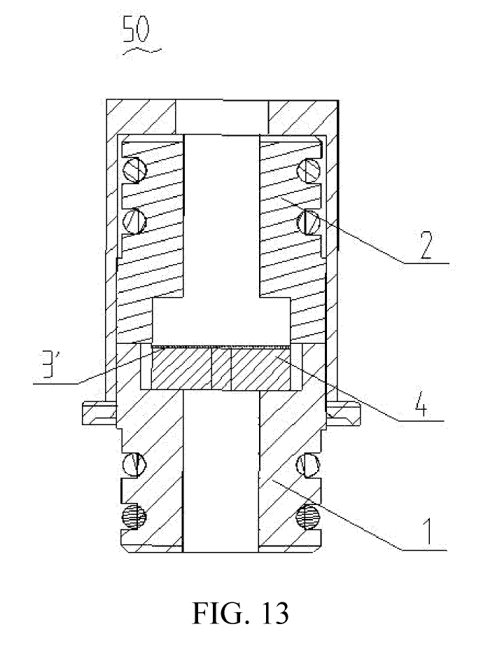

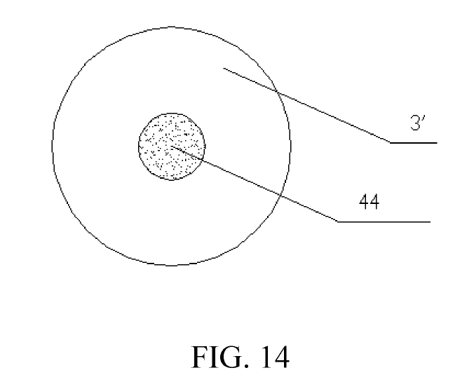

Referring to FIG. 13 and FIG. 14, the fifth embodiment of the present disclosure provides a mono-directional mouthpiece 50 for an electronic cigarette, the mono-directional mouthpiece 50 includes a first valve 1, a blocking plate 4, a mono-directional membrane 3′, a fixing member 44, and a second valve 2. The difference between the fifth embodiment and the second embodiment is that: the fixing member 44 is an adhering portion positioned on the blocking plate 4 and/or an adhering portion positioned on the mono-directional membrane 3′, causing a portion of the mono-directional membrane 3′ to be adhered to and fixed to the blocking plate 4. In the illustrative embodiment, the adhering portion is positioned on the mono-directional membrane 3′.

### The Sixth Embodiment

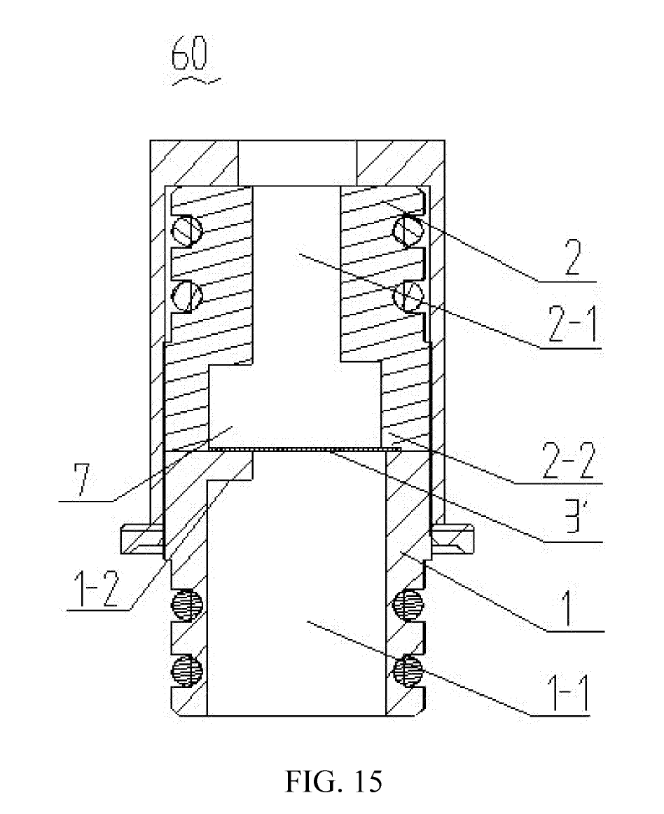

Referring to FIG. 15, the sixth embodiment of the present disclosure provides a mono-directional mouthpiece 60 for an electronic cigarette, the mono-directional mouthpiece 60 includes a first valve 1, a mono-directional membrane 3′ and a second valve 2. The difference between the sixth embodiment and the second embodiment is that: the mono-directional mouthpiece 60 does not include a blocking plate 4 and a fixing member 14. The second valve 2 is provided with a second fixing portion 2-2 at an inner wall, which is configured for fixing a portion of the mono-directional membrane 3′ to a connecting portion of the first valve 1 and the second valve 2. The first valve 1 is provided with a resisting portion 1-2 at an inner wall of the first valve 1 which is corresponding to the second fixing portion 2-2, the resisting portion 1-2 is configured to resist the movable portion of the mono-directional membrane 3′ to move toward the first valve 1. The second valve 2 defines a moving space 7 therein for the movable portion of the mono-directional membrane 3′ to move toward the second valve 2. The first valve 1 defines a first valve airway 1-1, the second valve 2 defines a second valve airway 2-1, when the movable portion of mono-directional membrane 3′ moves towards the second valve 2, the first valve airway 1-1 and the second valve airway 2-1 fluidly communicate with each other, for user to swallow.

### The Seventh Embodiment

Referring to FIG. 16, the seventh embodiment of the present disclosure provides an atomizer 100′, the atomizer 100′ includes an atomizing body 120′ and a mono-directional mouthpiece assembled to the atomizing body 120′.

The seventh embodiment of the present disclosure further discloses an electronic cigarette 200′, the electronic cigarette 200′ includes an atomizing body 120′, a mono-directional mouthpiece assembled to the atomizing body 120′ and a battery pack 130′ configured to supply power for the atomizing body 120′. The battery 130′ is assembled to an end of the atomizing body 120′ distal from the mono-directional mouthpiece.

Wherein, the mono-directional mouthpiece is a mono-directional mouthpiece selected from one of the mono-directional mouthpiece (20, 30, 40, 50, 60) of the second embodiment to the sixth embodiment.

The embodiments described above are merely preferred embodiments, but not intended to limit the application. Any modifications, alternatives or improvements made within the principle and spirit of the present application should be interpreted as falling within the protection scope of the present application.

What is claimed is:

1. A mono-directional mouthpiece, comprising:
a first valve defining a first valve airway;
a second valve fixedly connected to the first valve and defining a second valve airway;
a blocking plate defining a blocking plate airway fluidly communicating with the first valve airway and the second valve airway; and
an elastic member;
wherein connecting ends of the first valve and the second valve which connect the first valve to the second valve both define a groove, the two grooves are defined on corresponding positions of the two connecting ends respectively, the two grooves fluidly communicate with each other to form a moving space, the blocking plate and the elastic member are positioned in the moving space, the blocking plate is positioned in the groove of the first valve which is located at a bottom of the first valve, an end of the elastic member resists the blocking plate, an opposite end of the elastic member extends into an inner of the groove of the second valve, the blocking plate is capable of moving along an axial direction of the moving space reciprocally.

2. The mono-directional mouthpiece according to claim 1, further comprising a mouthpiece cover, wherein the mouthpiece cover is mounted on the first valve or the second valve.

3. The mono-directional mouthpiece according to claim 1, wherein the blocking plate comprises a guiding post, the blocking plate airway is defined on the guiding post, the first valve airway, the second airway and the blocking plate airway fluidly communicate with each other.

4. The mono-directional mouthpiece according to claim 1, further comprising a sealing ring, wherein the sealing ring is positioned on a portion of the first valve which is connected to a mouthpiece cover or an atomizing body, or the sealing ring is positioned on a portion of the second valve which is connected to a mouthpiece cover or an atomizing body.

5. The mono-directional mouthpiece according to claim 1, wherein the first valve is fixedly connected to the second valve by any one or any combination of connecting types selected from microwave joining, hot melting, screwing or latching.

6. The mono-directional mouthpiece according to claim 1, wherein the first valve and/or the second valve are/is marked, for distinguishing the first valve from the second valve.

7. An atomizer, comprising an atomizing body and a mouthpiece positioned on the atomizing body, wherein the mouthpiece is the mono-directional mouthpiece according to claim 1.

8. A mono-directional mouthpiece, comprising:
a first valve defining a first valve airway;
a second valve fixedly connected to the first valve and defining a second valve airway;
a blocking plate defining a blocking plate airway;
a mono-directional membrane; and
a fixing member;
wherein a connecting end of the first valve connecting with the second valve defines a groove, the blocking plate is resisted in the groove of the first valve, the fixing member fixes a portion of the mono-directional membrane to the blocking plate, the second valve defines a moving space therein for a movable portion of the mono-directional membrane to move toward the second valve, when the movable portion of the mono-directional membrane moves toward the second valve, the first valve airway and the second valve airway fluidly communicate with each other via the blocking plate airway.

9. The mono-directional mouthpiece according to claim 8, wherein the fixing member is a protrusion positioned on a central of a fixing plate, the protrusion resists a central of the mono-directional membrane on the blocking plate to fix the mono-directional membrane to the blocking plate, a connecting end of the second valve connecting with the first valve defines a groove, the fixing plate is positioned in the groove of the second valve, the fixing plate defines a fixing plate airway, when the movable portion of the mono-directional membrane moves toward the second valve, the first valve airway, the blocking plate airway, the fixing plate airway, and the second valve airway fluidly communicate with each other.

10. The mono-directional mouthpiece according to claim 8, wherein the fixing member is a magnetic member, at least a portion of the blocking plate is magnetic, when the fixing member and the blocking plate are magnetic sucked together, a portion of the mono-directional membrane positioned between the fixing member and the blocking plate is fixed.

11. The mono-directional mouthpiece according to claim 8, wherein the fixing member comprises a first fixing portion and a resisting portion, the first fixing portion is embedded into the blocking plate, causing the fixing member to be fixed to the blocking plate, the resisting portion resists a portion of the membrane on the blocking plate.

12. The mono-directional mouthpiece according to claim 8, wherein the fixing member is an adhering portion positioned on the blocking plate and/or an adhering portion positioned on the mono-directional membrane, the mono-directional membrane is partially adhered to and fixed to the blocking plate.

13. The mono-directional mouthpiece according to claim 8, further comprising a mouthpiece cover, wherein the mouthpiece cover is mounted on the first valve or the second valve, the mouthpiece defines a mouthpiece cover airway.

14. The mono-directional mouthpiece according to claim 8, further comprising a sealing ring, wherein the sealing ring is positioned on a portion of the first valve which is connected to a mouthpiece cover or an atomizing body, or the sealing ring is positioned on a portion of the second valve which is connected to a mouthpiece cover or an atomizing body

15. The mono-directional mouthpiece according to claim 8, wherein the first valve is fixedly connected to the second valve by any one or any combination of connecting types selected from microwave joining, hot melting, screwing or latching.

16. The mono-directional mouthpiece according to claim 8, wherein at least one of the first valve and the second valve is marked, for distinguishing the first valve from the second valve.
